(19) United States
(12) Patent Application Publication
(10) Pub. No.: US 2026/0235758 A1
(43) Pub. Date: Aug. 13, 2026

(54) MOVABLE CAMERA WITH LIDAR FOR SPORTS BROADCASTING AND GAMEPLAY

(71) Applicant: Fox Sports Productions, LLC, Los Angeles, CA (US)

(72) Inventors: Zachary Fields, Woodland Hills, CA (US); Michael Davies, Los Angeles, CA (US); Juan Wee, Los Angeles, CA (US); Steve Wharton, Los Angeles, CA (US); Tim Demers, Los Angeles, CA (US)

(21) Appl. No.: 19/534,068

(22) Filed: Feb. 9, 2026

Related U.S. Application Data
(60) Provisional application No. 63/755,698, filed on Feb. 7, 2025.

(51) Int. Cl. G01S 17/86; A63B 71/06; G01S 7/481; G01S 17/08; G01S 17/66; G01S 17/89; G03B 17/56; G06V 20/20; G06V 20/40; G06V 40/10; H04N 23/611; H04N 23/695; H04N 23/90

(52) U.S. Cl. CPC G01S 17/86; A63B 71/0605; A63B 71/0622; G01S 7/4813; G01S 17/08; G01S 17/66; G01S 17/89; G03B 17/561; G06V 20/20; G06V 20/42; G06V 20/44; G06V 40/10; H04N 23/611; H04N 23/695; H04N 23/90; A63B 2071/0636; A63B 2071/0647; A63B 2220/05; A63B 2220/13; A63B 2220/806; A63B 2220/89; A63B 2243/0025

(57) ABSTRACT

Improvements regarding aspects of football are described, including with regard to tools and methods facilitating game and league play, as well as tools and methods for broadcast, including capture and presentation of broadcast for football.

### CROSS REFERENCE TO RELATED APPLICATIONS

The present application claims priority to U.S. Provisional Patent Application No. 63/755,698, filed Feb. 7, 2025, the entire contents of which are incorporated herein by reference.

### FIELD

The present technology is generally related to football or other sports, including league play and broadcasting.

### BACKGROUND

The present disclosure describes various improvements regarding aspects of football or other sports, including with regard to tools and methods facilitating game and league play, as well as tools and methods for broadcast, including capture and presentation of broadcast for football, more specifically to improvements related to image capture, object location and graphics presented during broadcast.

### SUMMARY

The techniques of this disclosure generally relate to various improvements regarding aspects of football or other sports, including with regard to tools and methods facilitating game and league play, as well as tools and methods for broadcast, including capture and presentation of broadcast for football, including exemplary aspects related to improvements related to image capture, object location and graphics presented during broadcast.

In one exemplary embodiment, systems and methods described herein provide an improved suspended camera, or skycam, that integrates Lidar measurement therefrom to assist in object location, viewing of occluded action and overlay or underlay of graphics during broadcast. While a suspended camera, or skycam, is described and depicted, it should be understood that the present technology and techniques apply to any camera/Lidar combination that moves in a venue, since the Lidar provides the information to accurately locate the camera in a 3D space.

In exemplary embodiments, the suspended camera and Lidar package are provided with various axes of motion by suspension lines, including left, right, up, down, etc. Such technology advantageously provides for increased accuracy in locating objects and can remedy occluded action by taking advantage of highlighting of objects to show the location of the objects during such occluded action, e.g., to show the location or estimated location of a football during a tackle, where the ball might otherwise not be thoroughly shown on screen. The present disclosure recognizes that in exemplary aspects, the object(s)′ location may be determined via computer tracking, over time; however, during occluded action, exclusive use of computer tracking may lead to inaccuracies without further use of location indicators. Use of Lidar on the camera package alleviates these concerns.

We also note that the located object may be other than a ball, e.g., a shoe, a helmet, an article of clothing, a club, a bat, a drone, etc. Additionally, plural cameras, some with or without Lidar may, in concert, assist in more accurately determining the position of objects on the field and allow for more accurate placement of graphics.

Further, such systems (including automatic processing of received and/or transmitted data) may determine whether an object (e.g., a ball, player, shoe, etc.) has crossed wholly or at least partially over one of those lines, markers, posts, etc., which may have relevance to rules of play. Additionally, such systems (including automatic processing of received and/or transmitted data) may determine whether an object (e.g., a ball, player, shoe, a particular player's shoe (or even the outside of one of a player's shoe), etc.) has crossed wholly or at least partially over one of those lines, markers, posts, etc., and re-entered the field, which may have relevance to rules of play.

The object (e.g., a football) could be shown on-screen or on a GUI/display as a glowing object or outline of an object, even e.g., under the occluding mass of plural players, as a location, e.g., relative to a first down or goal, or otherwise. In further exemplary embodiments, data from sensors within the ball, alone or in combination with observed characteristics of the ball over a time period, can be used to further show aspects of that ball, e.g., showing rotation of the ball in the air, deflections, changes in rotations due to deflections, etc., via highlights or animation or otherwise.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a front perspective view of an exemplary GUI or display of football action, including occluded action using highlighting for occluded object(s);

FIG. 2 is a perspective view of a moving camera with Lidar, in accordance with exemplary embodiments described herein;

FIG. 3 is a screenshot of a user interface or screen illustrating rendered objects and markers in a 3D environment, in accordance with exemplary embodiments described herein;

FIG. 4 is a screenshot of an exemplary broadcast with augmented reality aspects provided thereon, in accordance with exemplary embodiments described herein; and

FIG. 5 is a screenshot of an exemplary broadcast with inserted graphics, in accordance with exemplary embodiments described herein.

### DETAILED DESCRIPTION

As we have noted, the present disclosure describes various improvements regarding aspects of football or other sports, including with regard to tools and methods facilitating game and league play, as well as tools and methods for broadcast, including capture and presentation of broadcast for football. While a suspended camera, or skycam, is described and depicted, it should be understood that the present technology and techniques apply to any camera/Lidar combination that moves in a venue, since the Lidar provides the information to accurately locate the camera in a 3D space.

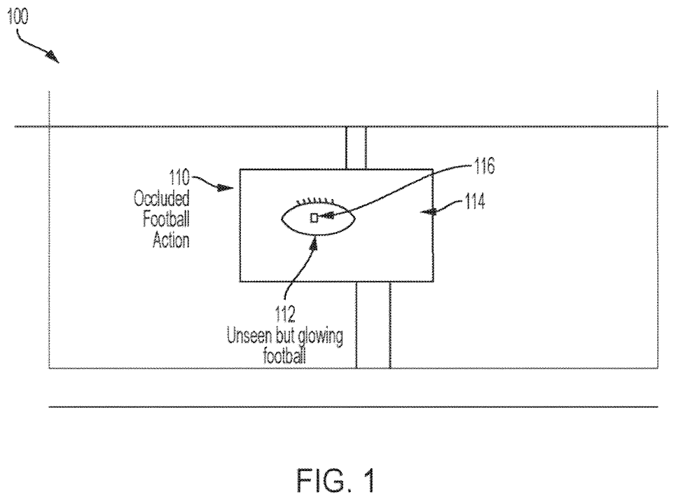

FIG. 1 illustrates generally at 100 a first exemplary embodiment, showing occluded action generally at 110, including showing an object/ball 112 on a broadcast image, GUI or screen 114. In one exemplary embodiment, systems and methods described herein remedy occluded action by taking advantage of highlighting of objects to show the location of the objects during such occluded action, e.g., to show the location or estimated location of a football during a tackle, where the ball might otherwise not be thoroughly shown on screen. While in exemplary aspects, the object(s)′ location may be determined via computer tracking, over time, via location indicators, such as global positioning satellite (GPS) or other location chips (e.g., chip 116) or emitters (e.g., providing location within one or more frames of reference or to plural camera sources from different angles), etc., the present disclosure provides for an exemplary suspended camera that also integrates a Lidar unit thereon.

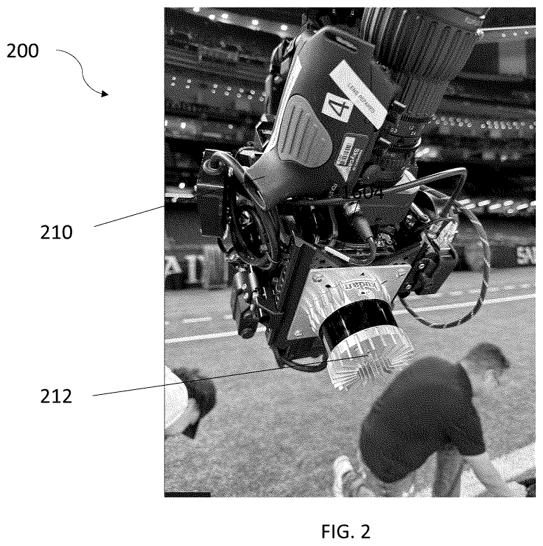

FIG. 2 illustrates generally at 200 a moving camera 210 (or skycam) with an attached Lidar rig 212). In exemplary embodiments, the lidar rig is bolted to a surface of the moving camera. In exemplary aspects, the Lidar system is used prior to an event to scan a 3D environment, followed by creation of a 3D environment via one or more processors/computers. When flying around, the Lidar unit is used to recognize where the camera is in 3D space relative to the 3D model, which allows the system to know camera location and to provide tracking data. In the graphics engine informed positioning of the 3D images are composited within the frame.

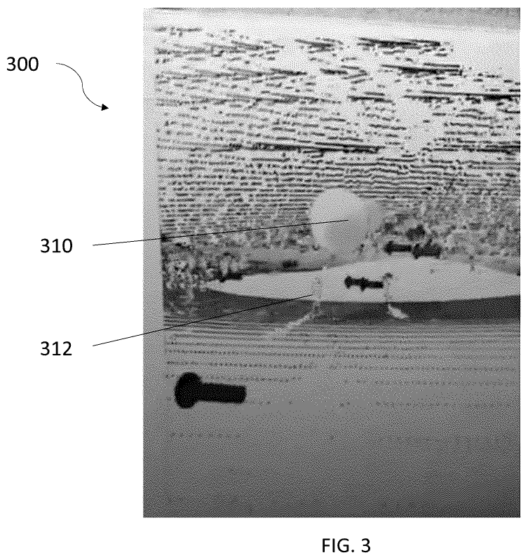

FIG. 3 illustrates the computer processor's/graphic engine's rendering of the 3D environment generally at 300, with camera tracking relative to positional markers 310 in the 3D environment by virtue of the lidar, and with object tracking, e.g., at 312. In the illustrated exemplary image, a first marker 310, which may for ease of identification have an assigned color, such as yellow, depicts the location of the camera/Lidar package in three dimensional (3D) space. The other markers, which may be additionally differentiated by color, e.g., being blue and red, provide keyframing markers, which can be set so that the graphics engine knows where the camera/Lidar package is in the 3D space. Additional reference points can be marked, e.g., positional aspects of a field of play itself, during scanning/3D modeling prior to the event. A second camera/Lidar unit (or more than two) can also be used alongside a first camera to allow for more robust mapping and tracking.

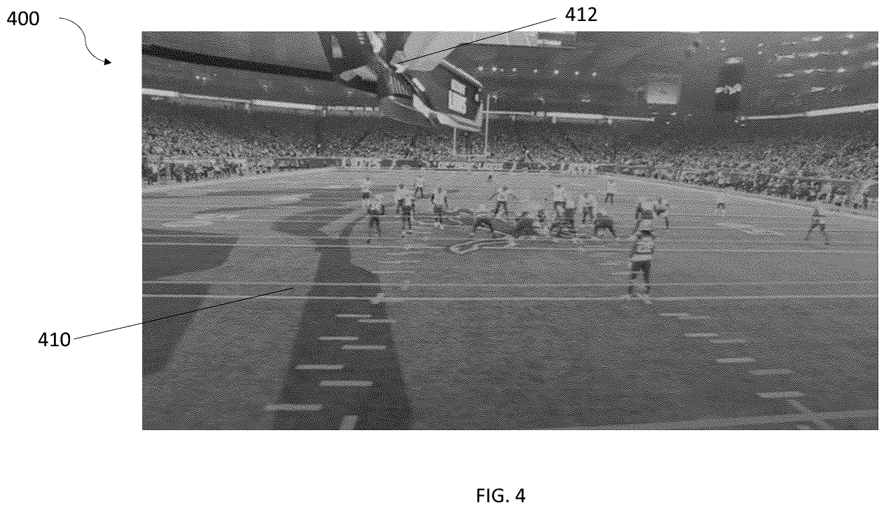

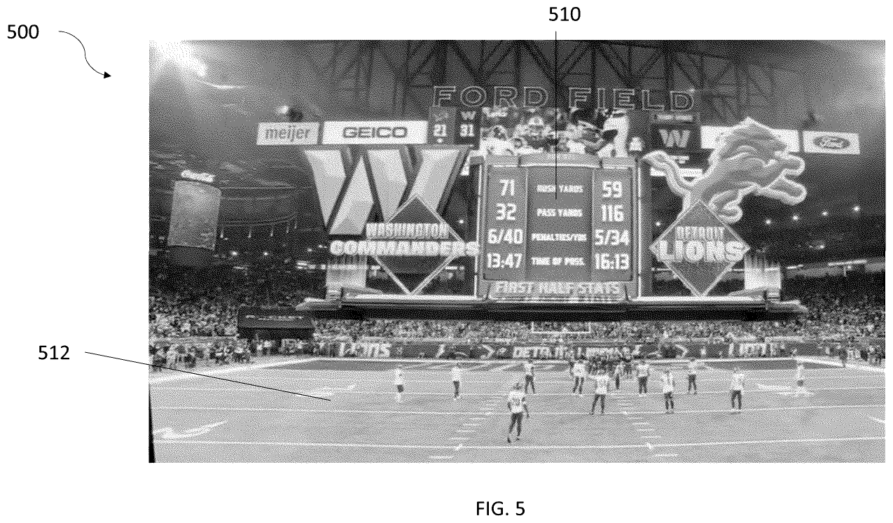

FIG. 4 shows an augmented reality image with mapped line markers 410 and overlaid graphics 412. FIG. 5 shows an exemplary broadcast, with overlaid scoreboards/graphics/advertisements 510, along with additional graphics 512 highlighted on the field.

In further exemplary embodiments, the Lidar provides depth perception to allow, e.g., placement of graphics under players and behind various foreground elements.

The object (e.g., football) could be shown on-screen or on a GUI/display as a glowing object or outline of an object, even e.g., under the occluding mass of plural players, as a location, e.g., relative to a first down or goal, or otherwise. In further exemplary embodiments, data from sensors within the ball, or observed characteristics of the ball over a time period, can be used to further show aspects of that ball, e.g., showing rotation of the ball in the air, deflections, changes in rotations due to deflections, etc., via highlights or animation or otherwise.

The object/ball can be shown in moving video with the ball glowing, and can be shown in various angles or views, such as in an overhead view. We also note that the located object may be other than a ball, e.g., a shoe, a helmet, an article of clothing, a club, a bat, a drone, etc. Additionally, plural detectors/receivers may, in concert, assist in more accurately determining the position of the emitted signal.

Further, such systems (including automatic processing of received and/or transmitted data) may determine whether an object (e.g., a ball, player, shoe, etc.) has crossed wholly or at least partially over one of those lines, markers, posts, etc., which may have relevance to rules of play. Additionally, such systems (including automatic processing of received and/or transmitted data) may determine whether an object (e.g., a ball, player, shoe, a particular player's shoe (or even the outside of one of a player's shoe), etc.) has crossed wholly or at least partially over one of those lines, markers, posts, etc., and re-entered the field, which may have relevance to rules of play.

The object (e.g., a football) could be shown on-screen or on a GUI/display as a glowing object or outline of an object, even e.g., under the occluding mass of plural players, as a location, e.g., relative to a first down or goal, or otherwise. In further exemplary embodiments, data from sensors within the ball, alone or in combination with observed characteristics of the ball over a time period, can be used to further show aspects of that ball, e.g., showing rotation of the ball in the air, deflections, changes in rotations due to deflections, etc., via highlights or animation or otherwise.

An exemplary system for determining the location of the objects during broadcast play action, provides a movable camera with a Lidar unit, and a processor configured to track an object of interest on or around a field of play during broadcast play action utilizing ingested live play action from a plurality of witness cameras, wherein the processor triangulates the location of the object of interest. In exemplary aspects, a user interface is provided configured to accept a remote operator's input to pinpoint the objects of interest, wherein the input is used alongside such triangulation to assist in pinpointing the object's location.

In exemplary aspects, the pinpointing of the object's location is accurate to within about 3 millimeters. Further, in exemplary aspects, the Lidar is also utilized by the processor to assist with pinpointing the object's location. The location can also be marked relative to one or more lines, markers, a first down line, etc., and can be used to determine whether e.g., a football has crossed at least partially over a first down line to determine whether a first down has been achieved. Additional witness cameras, e.g., three, can also be used, in various positions around the field of play.

A further operator or GUI can be provided to place graphics or to provide animation for the broadcast related to movement, tracking or placement of a ball, statistics for players, scores, advertising, etc.

In exemplary aspects, we have noted that the present disclosure relates to a moving camera and Lidar rig. In further exemplary embodiments, the moving camera and Lidar rig can provide current location of the camera within a rendered 3D space, e.g., with reference to a previous Lidar scan. In further exemplary embodiments, this facilitates tracking of objects, reveal of occluded play actions, and placement of graphics, advertisements, etc., among other advantages.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

What is claimed is:

1. A suspended broadcast camera system, comprising:
a suspension system, including plural anchored suspension lines and a motorized system configured to move the camera along the suspension lines in plural planes across a broadcast venue;
a broadcast camera mounted to the motorized system; and
a Lidar system mounted to the camera configured to provide the location of the camera and Lidar combination in a three dimensional (3D) space.

2. A suspended broadcast camera system in accordance with claim 1, wherein the camera and lidar combination are configured to provide location measurement for object location, viewing of occluded action and overlay or underlay of graphics during broadcast.

3. A suspended broadcast camera system in accordance with claim 1, wherein the camera and Lidar combination are configured to move along plural axes of motion including horizontal and vertical axes of motion.

4. A suspended broadcast camera system in accordance with claim 1, wherein the system further comprises a processor configured to locate objects and to highlight objects to show the location of the objects.

5. A suspended broadcast camera system in accordance with claim 4, wherein the processor tracks and shows the location of objects during occluded action.

6. A suspended broadcast camera system in accordance with claim 5, wherein the object is a football that is located on a field of play relative to line markers on the field of play.

7. A suspended broadcast camera system in accordance with claim 1, wherein a processor utilizes camera and lidar data from the system to accurately determine the position of objects on a field of play.

8. A suspended broadcast camera system in accordance with claim 7, wherein the system pulls live action play from plural cameras, including the suspended system, to accurately determine the positions of objects.

9. A suspended broadcast camera system in accordance with claim 7, wherein the system uses one or more cameras and lidar information from the suspended system to accurately place graphics on the broadcast.

10. A suspended broadcast camera system in accordance with claim 1, wherein a processor uses one or more cameras and lidar information from the suspended system to accurately determine whether the object has crossed wholly or partially over a line, marker or post on a field of play.

11. A suspended broadcast camera system in accordance with claim 10, wherein the object is a player's shoe or a portion of a player's shoe.

12. A suspended broadcast camera system in accordance with claim 11, wherein the system detects both of: if a portion of a player's shoe has wholly or at least partially crossed over a line; and whether that portion has reentered the field of play.

13. A suspended broadcast camera system in accordance with claim 5, wherein the object is highlighted on the broadcast.

14. A suspended broadcast camera system in accordance with claim 5, wherein the object is a ball that is provided on the broadcast with graphics indicating aspects of ball movement, including rotation of the ball.
